(19) United States
(12) Patent Application Publication
(10) Pub. No.: US 2025/0269993 A1
(43) Pub. Date: Aug. 28, 2025

(54) SYSTEMS AND METHODS FOR SERVICING AN AGRICULTURAL APPLICATOR

(71) Applicant: CNH Industrial America LLC, New Holland, PA (US)

(72) Inventor: Jamil Farhat, Spicer, MN (US)

(21) Appl. No.: 19/063,788

(22) Filed: Feb. 26, 2025

Related U.S. Application Data
(60) Provisional application No. 63/558,363, filed on Feb. 27, 2024.

(51) Int. Cl. B64U 70/93; A01C 21/00; A01M 7/00; B64U 101/40; B64U 101/45

(52) U.S. Cl. CPC B64U 70/93; A01C 21/00; A01M 7/0042; A01M 7/0085; A01M 7/0089; B64U 2101/40; B64U 2101/45

(57) ABSTRACT

A system for servicing an agricultural applicator includes an agricultural applicator configured as a UAV configured to fly over a field, the agricultural applicator including an applicator tank for holding agricultural product configured to be dispensed by the agricultural applicator during an application operation, and a power source port configured to receive a power source for powering the agricultural applicator. The system further includes a platform on which the agricultural applicator rests during a servicing operation, the platform defining at least one opening. Moreover, the system includes a refill tank connectable during the servicing operation to the applicator tank through the at least one opening for supplying the agricultural product from the refill tank to the applicator tank. Additionally, the system includes a power source station for supplying the power source to the power source port through the at least one opening during the servicing operation.

### CROSS REFERENCE TO RELATED APPLICATION

The present application is based upon and claims the right of priority to U.S. Provisional Patent Application No. 63/558,363 filed on Feb. 27, 2024, the entirety of which is incorporated by reference herein for all purposes.

### FIELD

The present disclosure generally relates to agricultural applicators for performing spraying operations within a field and, more particularly, to systems and methods for servicing such agricultural applicators.

### BACKGROUND

Agricultural applicators or sprayers apply an agricultural product (e.g., an herbicide, fertilizer, fungicide, a pesticide, or another product) onto crops and/or a ground surface as the sprayer is traveling proximate to a field. In some instances, the sprayer can support one or more nozzle assemblies. Each nozzle assembly has a valve configured to control the spraying of the agricultural product through a nozzle onto underlying targets, which may include crops, weeds, a ground surface, and/or any other object.

In some instances, the agricultural sprayer may be an unmanned aerial vehicle (UAV). For example, UAVs may be flown across a field to apply agricultural product to the targets. However, the operating time for each of the UAVs is limited by the capacity of the applicator tanks on the UAVs holding the agricultural product and/or the capacity of the power source for operating the UAVs and the amount of time it takes to service the UAVs to refill the applicator tanks and/or recharge the power sources of the UAVs.

As such, systems and methods for servicing such agricultural applicators would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to a system for servicing an agricultural applicator. The system may include an agricultural applicator configured as a UAV configured to fly over a field, where the agricultural applicator includes an applicator tank for holding agricultural product configured to be dispensed by the agricultural applicator during an application operation, and a power source port configured to receive a power source for powering the agricultural applicator. The system may further include a platform on which the agricultural applicator is configured to rest during a servicing operation, where the platform defines at least one opening. Moreover, the system may include a refill tank configured to hold the agricultural product, with the refill tank being connectable during the servicing operation to the applicator tank through the at least one opening for supplying the agricultural product from the refill tank to the applicator tank. Additionally, the system may include a power source station, the power source station supplying the power source to the power source port through the at least one opening during the servicing operation.

In some aspects, the present subject matter is directed to a base station for servicing agricultural applicators configured as UAVs. The base station may include a frame, a storage housing supported on the frame and defining an interior volume, and a platform defined on a roof of the storage housing. At least one opening is defined through the platform and the roof of the storage housing to the interior volume of the storage housing. The base station may additionally include a refill tank within the storage housing, where the refill tank is configured to hold agricultural product, and where the refill tank is connectable to a tank on an agricultural applicator through the at least one opening.

In some aspects, the present subject matter is directed to a method for servicing an agricultural applicator. The method may include determining, with a computing system, that an agricultural applicator configured as a UAV has landed on a platform. Additionally, the method may include automatically controlling, with the computing system, a tank refill device to begin supplying agricultural product from a refill tank connected through at least one opening defined in the platform to an applicator tank on the agricultural applicator when it is determined that the agricultural applicator has landed on the platform, the agricultural product being dispensable from the agricultural applicator during an application operation.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a schematic view of a system with various agricultural applicators and a base station in accordance with aspects of the present subject matter;

FIG. 2 illustrates a block diagram of various components of the system of FIG. 1 in accordance with aspects of the present subject matter;

FIGS. 3A-3D illustrate example aspects of a docking station for use with the system of FIGS. 1 and 2 in accordance with aspects of the present subject matter; and

FIG. 4 illustrates a flow diagram of one embodiment of a method for servicing agricultural applicators in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

As used throughout this disclosure, the term “autonomous” refers to a vehicle capable of implementing at least one operation without driver input. An “operation” refers to a change in one or more of the steering, braking, acceleration/deceleration of the vehicle, actuation of a component of an implement, actuation of a component of a trailer, and/or actuation of any other component of the vehicle and/or any assembly operably coupled with the vehicle. The term “semi-autonomous” refers to a vehicle capable of implementing at least one operation that is not fully automatic but assists the operator with such operation (e.g., fully operational without a driver or driver input). As such an autonomous vehicle includes those that can operate under operator control during certain time periods and without operator control during other time periods while a semi-autonomous vehicle includes those that can operate under operator control during certain time periods and assist with operator control during other time periods.

In general, the present subject matter is directed to systems and methods for servicing agricultural applicators, particularly agricultural applicators configured as UAVs. Specifically, in several embodiments, a UAV may have an applicator tank for holding an agricultural product to be dispensed by the agricultural applicator onto a field. Moreover, in several embodiments, the UAV may have a power source (e.g., battery and/or fuel tank) which may be used to power the UAV for flying and/or dispensing the agricultural product. A base station may be provided that has a platform on which a UAV may be supported during a servicing operation. The base station may have one or more features that help facilitate the servicing operation. For instance, the platform may define at least one opening through which an applicator tank on the UAV may be refilled/emptied and through which a power source (e.g., battery, fuel tank, etc.) on the UAV may be serviced (e.g., swapped out or refilled). The base station may have a refill tank configured to hold agricultural product for refilling the applicator tank of the UAV. Moreover, the base station may have a power source station configured for servicing the power source of the UAV. By providing the opening(s) in the platform (e.g., below the UAV), the connection between the applicator tank and the refill tank and/or the connection between the power source and the UAV may be more quickly and reliably made. As such, the base station significantly reduces the amount of time for servicing the agricultural applicator, which therefore increases the productivity of each agricultural applicator.

While the vehicles described below are generally illustrated and described as UAVs configured to perform a spraying operation, it will be appreciated that the UAVs may be configured to perform at least one of a planting process, a seeding process, and/or any other process in which an agricultural product is dispensed, and optionally, a mapping process, a scouting process, and/or the like. In addition, it will be appreciated that the UAVs may be human-controlled, autonomously controlled, and/or semi-autonomously controlled without departing from the teachings provided herein.

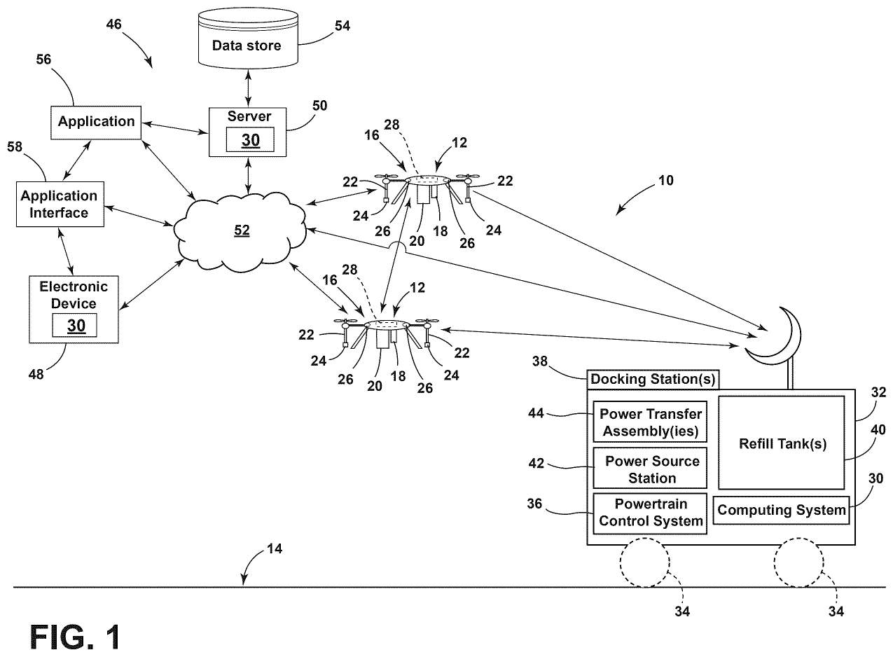

Referring now to FIG. 1, a system 10 for an agricultural operation is illustrated in accordance with aspects of the present subject matter. As shown in FIG. 1, the system may generally include one or more unmanned aerial vehicles (UAVs) 12 configured to be flown over a field 14 to perform one or more operations. For instance, the UAVs 12 may be configured to dispense an agricultural product (e.g., an herbicide, fertilizer, fungicide, pesticide, or another product) onto the underlying field, collect data associated with one or more objects within the field, collect data associated with a topology for the field, and/or perform any other operation.

Each UAV 12 can include a propulsion system 16 that generates movement of the UAV. The propulsion system 16 may be powered by a power source, such as a battery 18, that is operably coupled with the UAV 12. As such, the propulsion system 16 of the UAV 12 may allow the UAV to perform controlled vertical, or nearly vertical, takeoffs and landings. For instance, in the illustrated embodiment, each of the UAVs 12 corresponds to a quadcopter in which the propulsion system powers each of four rotors to maneuver the vehicle. However, in other embodiments, one or more of the UAVs 12 may correspond to any other multi-rotor aerial vehicle, such as a tricopter, hexacopter, or octocopter. In still further embodiments, one or more of the UAVs 12 may be a single-rotor helicopter, or a fixed-wing, hybrid vertical takeoff, and landing aircraft. Still further, it will be appreciated that the UAV(s) 12 may be implemented as any other manned or unmanned vehicle, or combination of types of vehicles, capable of performing any of the functions described herein through operator input, semi-autonomously, and/or autonomously without departing from the scope of the present disclosure.

Each of the UAVs 12 may also include a product tank 20. The product tank 20 is generally configured to store or hold an agricultural product, such as an herbicide, fertilizer, fungicide, pesticide, or another product. The agricultural product is conveyed from the product tank 20 through a product circuit including plumbing components 22, such as interconnected pieces of tubing, for release onto the underlying field (e.g., plants and/or soil) through one or more nozzle assemblies 24. Each nozzle assembly 24 may include, for example, a spray nozzle and an associated valve for regulating the flow rate of the agricultural product through the nozzle (and, thus, the application rate of the nozzle assembly), thereby allowing the desired spray characteristics of a spray fan of the agricultural product expelled from the nozzle to be achieved. In some instances, each valve may be selectively activated to direct an agricultural product towards a defined target. For instance, each valve may be selectively activated to deposit a suitable herbicide toward a detected/identified weed and/or a nutrient toward a detected/identified crop.

In several embodiments, the UAV(s) 12 may include one or more sensors 26 to collect data associated with the UAV, an additional UAV, one or more objects within the field 14, a topology for the field 14, and/or any other information. For instance, the UAV(s) 12 may selectively activate one or more nozzle assemblies to deposit a suitable herbicide toward a detected/identified weed and/or a nutrient toward a detected/identified crop based on data from the one or more sensors. In some examples, the sensors 26 can include one or more spray sensors, orientation sensors, pressure sensors, propulsion sensors, energy sensors, a weather station, and/or any other sensing assembly. For instance, suitable spray sensors (e.g., an imaging sensor, a LIDAR, a RADAR, or any other suitable type of sensor) may be configured to capture data related to the one or more spray fans. Similarly, suitable orientation sensors (e.g., an imaging sensor, a LIDAR, a RADAR sensor, a Hall effect sensor, a gyroscope sensor, a magnetometer sensor, an accelerometer sensor, a yaw-rate sensor, a piezoelectric a position sensor, a complementary metal-oxide-semiconductor (CMOS) sensor, a pressure sensor, a capacitive sensor, an ultrasonic sensor, or any other suitable type of sensor) may be configured to capture data related to a position, angle, displacement, distance, speed, acceleration of the UAV. Suitable pressure sensors (e.g., a diaphragm pressure sensor, a piston pressure sensor, a strain gauge-based pressure sensor, an electromagnetic pressure sensor, or any other suitable type of sensor) may be configured to capture data indicative of the pressure of the agricultural product being supplied to or through the nozzle assemblies 24. Suitable propulsion sensors may be configured to capture data related to one or more components of the propulsion system. Suitable energy sensors may be configured to capture data related to an amount of usable energy for the UAV. In examples in which the sensor(s) 26 corresponds to or includes a camera, a single-spectrum camera or a multi-spectrum camera may be implemented and configured to capture image data, for example, in the visible light range and/or infrared spectral range. Additionally, in various embodiments, the cameras may correspond to a single lens camera configured to capture two-dimensional image data or a stereo cameras having two or more lenses with a separate image imaging device for each lens to allow the cameras to capture stereographic or three-dimensional image data.

In addition, the UAVs 12 may also support one or more additional components, such as an on-board computing device 28. In general, the UAV computing device 28 may be configured to control the operation of the UAV 12, such as by controlling the propulsion system 16 of the UAV to cause the UAV to be moved relative to the field 14. For instance, in some embodiments, the UAV computing device 28 may be configured to receive flight plan data associated with a proposed flight plan for the associated UAV 12, such as a flight plan selected such that the UAV makes one or more passes across the field 14 in a manner that allows the agricultural product to be applied to a defined target. Based on such data, the UAV computing device 28 may control the operation of the UAV 12 such that the UAV is flown across the field 14 according to the proposed flight plan.

Additionally, as shown in FIG. 1, the system 10 may also include one or more remote computing systems 30 separate from or remote to the UAVs 12. In several embodiments, the remote computing system(s) 30 may be communicatively coupled to the UAV computing device(s) 28 to allow data to be transmitted between the UAV(s) 12 and the remote computing system(s). For instance, in various embodiments, the remote computing system(s) 30 may be configured to transmit instructions or data to the UAV computing device(s) 28 that is associated with the flight plan across the field 14. Similarly, the UAV computing device(s) 28 may be configured to transmit or deliver the data collected by the sensor(s) 26 to the remote computing system(s) 30.

The remote computing system(s) 30 may correspond to a stand-alone component or may be incorporated into or form part of a separate component or assembly of components. For example, in various embodiments, the remote computing system(s) 30 may form part of a base station 32. In such an embodiment, the base station 32 may be portable, such as by being transportable to a location within or near the field 14, or the base station 32 may be disposed at a fixed location, such as a farm building or central control center, which may be proximal or remote to the field 14. In instances in which the base station 32 is portable, the base station may include one or more base station wheels 34. The one or more base station wheels 34 may be configured to support the base station 32 relative to the field. In some embodiments, the base station 32 may also include a powertrain control system 36 that may include a power plant, such as an engine, a motor, or a hybrid engine-motor combination, a transmission or hydraulic propel system configured to transmit power from the power plant to the one or more base station, and/or a brake system.

As shown in FIG. 1, in various embodiments, the base station 32 may further include various systems and components for supporting the UAVs 12. For instance, the base station 32 may include a docking station 38, which may be positioned on a top portion of the base station and/or at any other location. The base station 32 may further include one or more refill tanks 40 and/or a power source station 42. The refill tank(s) 40 may be configured to store additional agricultural products, a rinse fluid, and/or any other fluid that may be transferred to the UAVs 12, such as when the UAV(s) is located on the docking station 38. The power source station 42 may store one or more power sources, such as one or more batteries (e.g., battery 18), that may be operably couplable with the UAV 12. In some instances, the power sources may be transferred from the power source station 42 to the docking station (or any other location) through a power transfer assembly 44 such that the power source within a UAV 12 may be replaced and/or refilled with supplemental energy. In some instances, instead of, or in addition to, the UAVs 12 using replaceable and/or rechargeable batteries 18, the UAVs may run on other fuels (e.g., gasoline, diesel, hydrogen, etc.), in which case the power source station 42 may store such other fuels and the transfer assembly 44 may be used to replace/refill tank(s) on the UAVs 12 for storing such other fuels.

With further reference to FIG. 1, in other embodiments, the one or more remote computing systems or devices 30 may correspond to or form part of a remote cloud-based system 46. For instance, the UAV(s) 12, the base station 32, and/or an electronic device 48 may be communicatively coupled with one another and/or one or more remote sites, such as a remote server 50 via a network/cloud 52 to provide data and/or other information therebetween. The network/cloud 52 represents one or more systems by which the UAV(s) 12, the base station 32, and/or the electronic device 48 may communicate with the remote server 50. The network/cloud 52 may be one or more of various wired or wireless communication mechanisms, including any desired combination of wired and/or wireless communication mechanisms and any desired network topology (or topologies when multiple communication mechanisms are utilized). Example communication networks 52 include wireless communication networks (e.g., using Bluetooth, IEEE 802.11, etc.), local area networks (LAN), and/or wide area networks (WAN), including the Internet and the Web, which may provide data communication services and/or cloud computing services. The Internet is generally a global data communications system. It is a hardware and software infrastructure that provides connectivity between computers. In contrast, the Web is generally one of the services communicated via the Internet. The Web is generally a collection of interconnected documents and other resources, linked by hyperlinks and URLs. In many technical illustrations when the precise location or interrelation of Internet resources are generally illustrated, extended networks such as the Internet are often depicted as a cloud (e.g. 52 in FIG. 1). The verbal image has been formalized in the newer concept of cloud computing. The National Institute of Standards and Technology (NIST) defines cloud computing as “a model for enabling convenient, on-demand network access to a shared pool of configurable computing resources (e.g., networks, servers, storage, applications, and services) that can be rapidly provisioned and released with minimal management effort or service provider interaction.” Although the Internet, the Web, and cloud computing are not the same, these terms are generally used interchangeably herein, and they may be referred to collectively as the network/cloud 52.

The server 50 may be one or more computing devices, each of which may include at least one processor and at least one memory, the memory storing instructions executable by the processor, including instructions for carrying out various steps and processes. The server 50 may include or be communicatively coupled to a data store 54 for storing collected data as well as instructions for the UAV(s) 12, the base station 32, and/or the electronic device 48 with or without intervention from a user, the UAV(s) 12, the base station 32, and/or the electronic device 48. Moreover, the server 50 may be capable of analyzing initial or raw sensor data received from the UAV(s) 12, the electronic device 48, and/or the base station 32, and final or post-processing data (as well as any intermediate data created during data processing). Accordingly, the instructions provided to any one or more of the UAV(s) 12, the base station 32, and/or the electronic device 48 may be determined and generated by the server 50 and/or one or more cloud-based applications 56. In such instances, a user interface for the UAV(s) 12, a user interface for the base station 32, and/or the electronic device 48 may be a dummy device that provides various notifications based on instructions from the network/cloud 52.

With further reference to FIG. 1, the server 50 also generally implements features that may enable the UAV(s) 12, the base station 32, and/or the electronic device 48 to communicate with cloud-based applications 56. Communications from the electronic device 48 can be directed through the network/cloud 52 to the server 50 and/or cloud-based applications 56 with or without a networking device, such as a router and/or modem. Additionally, communications from the cloud-based applications 56, even though these communications may indicate the UAV(s) 12, the base station 32, and/or the electronic device 48 as an intended recipient, can also be directed to the server 50. The cloud-based applications 56 are generally any appropriate services or applications 56 that are accessible through any part of the network/cloud 52 and may be capable of interacting with the electronic device 48.

In various examples, the UAV(s) 12, the base station 32, and/or the electronic device 48 can be feature-rich with respect to communication capabilities, i.e. have built-in capabilities to access the network/cloud 52 and any of the cloud-based applications 56 or can be loaded with, or programmed to have, such capabilities. The UAV(s) 12, the base station 32, and/or the electronic device 48 can also access any part of the network/cloud 52 through industry-standard wired or wireless access points, cell phone cells, or network nodes. In some examples, users can register to use the remote server 50 through the UAV(s) 12, the base station 32, and/or the electronic device 48, which may provide access to the UAV(s) 12, the base station 32, and/or the electronic device 48 and/or thereby allow the server 50 to communicate directly or indirectly with the UAV(s) 12, the base station 32, and/or the electronic device 48. In various instances, the UAV(s) 12, the base station 32, and/or the electronic device 48 may also communicate directly, or indirectly, with others of the UAV(s) 12, the base station 32, and/or the electronic device 48, or one of the cloud-based applications 56 in addition to communicating with or through the server 50. According to some examples, the UAV(s) 12, the base station 32, and/or the electronic device 48 can be preconfigured at the time of manufacture with a communication address (e.g. a URL, an IP address, etc.) for communicating with the server 50 and may or may not have the ability to upgrade or change or add to the preconfigured communication address.

Referring still to FIG. 1, when a new cloud-based application 56 is developed and introduced, the server 50 can be upgraded to be able to receive communications for the new cloud-based application 56 and to translate communications between the new protocol and the protocol used by the UAV(s) 12, the base station 32, and/or the electronic device 48. The flexibility, scalability, and upgradeability of current server technology render the task of adding new cloud-based application protocols to the server 50 relatively quick and easy.

In several embodiments, an application interface 58 may be operably coupled with the cloud 52 and/or the application 56. The application interface 58 may be configured to receive data related to the UAV(s) 12, the base station 32, and/or the electronic device 48. In various embodiments, one or more inputs related to the field data may be provided to the application interface 58. For example, a farmer, a vehicle user, a company, or other persons may access the application interface 58 to enter the inputs related to the field data. Additionally, or alternatively, the inputs related to the field data may be received from the remote server 50. For example, the inputs related to the field data may be received in the form of software that can include one or more objects (e.g., crops (crop rows, etc.), weeds, landmarks, targets, and/or the like within the field 14), agents, lines of code, threads, subroutines, databases, application programming interfaces (APIs), or other suitable data structures, source code (human-readable), object code (machine-readable). In response, the application 56 may update any input/output based on the received inputs. The application interface 58 can be implemented in hardware, software, or a suitable combination of hardware and software, and which can be one or more software systems operating on a general-purpose processor platform, a digital signal processor platform, or other suitable processors.

In some examples, at various predefined periods and/or times, the UAV(s) 12, the base station 32, and/or the electronic device 48 may communicate with the server 50 through the network/cloud 52 to obtain the stored instructions, if any exist. Upon receiving the stored instructions, the UAV(s) 12, the base station 32, and/or the electronic device 48 may implement the instructions. In some instances, the UAV(s) 12, the base station 32, and/or the electronic device 48 can send event-related data to the server 50 for storage in the data store 54. This collection of event-related data can be accessed by any number of users, the UAV(s) 12, the base station 32, and/or the electronic device 48 to assist with application processes.

In some instances, the electronic device 48 may also access the server 50 to obtain information related to stored events. The electronic device 48 may be a mobile device, tablet computer, laptop computer, desktop computer, watch, virtual reality device, television, monitor, or any other computing device or another visual device.

In various embodiments, the data used by the UAV(s) 12, the base station 32, the electronic device 48, the remote server 50, the data store 54, the application 56, the application interface 58, and/or any other component described herein for any purpose may be based on data provided by the one or more sensors and/or third-party data that may be converted into comparable data that may be used independently or in conjunction with data collected from the one or more sensors.

In various examples, the server 50 may implement machine learning engine methods and algorithms that utilize one or several machine learning techniques including, for example, decision tree learning, including, for example, random forest or conditional inference trees methods, neural networks, support vector machines, clustering, and Bayesian networks. These algorithms can include computer-executable code that can be retrieved by the server 50 through the network/cloud 52 and may be used to generate a predictive evaluation of the field 14. In some instances, the machine learning engine may allow for changes to a map of the field 14 to be updated without human intervention.

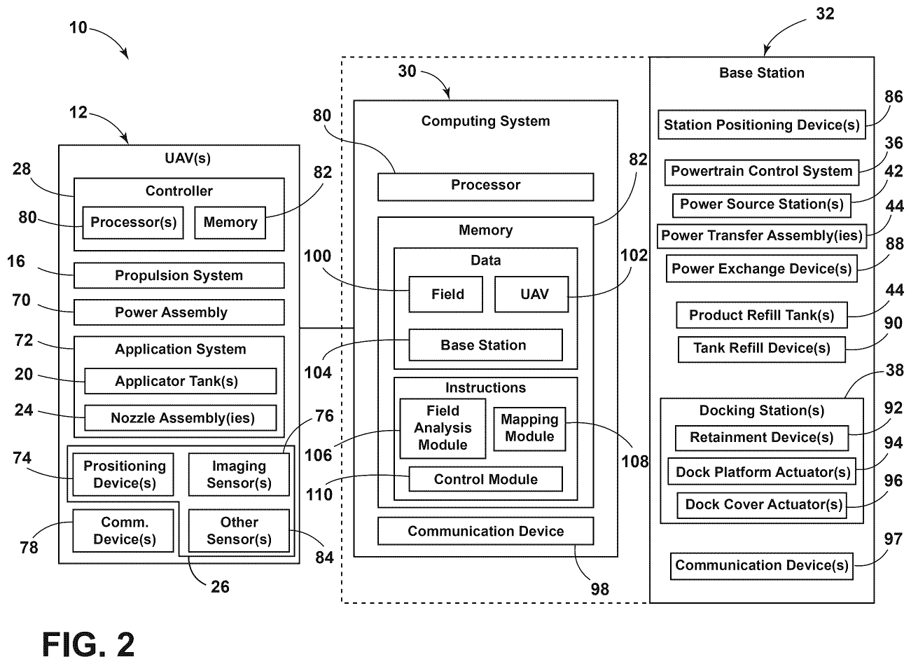

Referring now to FIG. 2, a schematic view of components of the system 10 of FIG. 1 is illustrated in accordance with aspects of the present subject matter. Particularly, the system 10 is described in FIG. 2 with reference to one of the UAVs 12, and the base station 32 from FIG. 1. It should be appreciated, however, that, in other embodiments, the disclosed system 10 may have any other suitable system configuration or architecture and/or may incorporate any other suitable components and/or combination of components that generally allow the system 10 to function as described herein.

As described above with reference to FIG. 1, the system 10 may include one or more UAVs, such as the UAVs 12, where each UAV 12 may include and/or be configured to support various components, such as one or more computing devices, propulsion systems, power assemblies, application systems, and sensors. For instance, the UAV 12 may include the on-board computing device(s) 28, the propulsion system(s) 16, one or more power assemblies 70 (e.g., including the battery (ies) 18), one or more application systems 72 (e.g., including the product tank 20, the plumbing components 22, the nozzle assembly(ies) 24, etc.), the sensor(s) 26 (e.g., including one or more positioning devices 74, one or more imaging sensors 76, and/or one or more other sensors 84), and/or one or more communication devices 78.

In general, the UAV computing device 28 may correspond to any suitable processor-based device(s), such as a computing device or any combination of computing devices. Thus, in several embodiments, the UAV computing device 28 may include one or more processor(s) 80 and associated memory device(s) 82 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 82 of the UAV computing device 28 may generally comprise memory element(s) including, but not limited to, computer readable medium (e.g., random access memory (RAM)), computer readable non-volatile medium (e.g., a flash memory), a compact disc-read only memory (CD-ROM), a magneto-optical disk (MOD), a digital versatile disc (DVD) and/or other suitable memory elements. Such memory device(s) 82 may generally be configured to store suitable computer-readable instructions that, when implemented by the processor(s) 80, configure the UAV computing device 28 to perform various computer-implemented functions. It should be appreciated that the UAV computing device 28 may also include various other suitable components, such as a communications circuit or module, a network interface, one or more input/output channels, a data/control bus, and/or the like.

In several embodiments, the UAV computing device 28 may be configured to automatically control the operation of one or more other components of the UAV 12. For instance, the UAV computing device 28 may be configured to control the propulsion system 16 of the UAV 12. For instance, as indicated above, the UAV computing device 28 may be configured to automatically control the propulsion system 16 in a manner that allows the UAV 12 to be flown across a field 14 according to a predetermined or desired flight plan. In this regard, the propulsion system 16 may include any suitable components that allow for the trajectory, speed, and/or altitude of the UAV 12 to be regulated, such as one or more power sources (e.g., one or more batteries 18 of the power assembly 70), one or more drive sources (e.g., one or more motors and/or engines), and one or more lift/steering sources (e.g., propellers, blades, wings, rotors, and/or the like). Similarly, as indicated above, the UAV computing device 28 may be configured to automatically control the application system 72 in a manner that allows the UAV 12 to selectively apply agricultural product to the field as the UAV 12 performs the flight plan. In this regard, the application system 72 may include any suitable components that allow for the dispensing of agricultural product by the UAV 12 to be regulated, such as the applicator tank(s) 20, the plumbing component(s) 22, the nozzle assembly (ies) 24, etc.

In various embodiments, the computing device 28 may be configured to monitor the position of the UAV 12 to control the propulsion system 16 and/or the application system 72. For instance, the positioning device(s) 74 may be configured to determine the exact location of the UAV 12 within the field 14 using a satellite navigation position system (e.g. a GPS, a Galileo positioning system, a Global Navigation satellite system (GLONASS), a BeiDou Satellite Navigation and

Positioning system, and/or the like), and/or a dead reckoning device. In such embodiments, the location determined by the positioning device(s) 74 may be transmitted to the UAV computing device 28 (e.g., in the form of coordinates) and stored within the memory 82 for subsequent processing and/or analysis. By monitoring the location of the UAV 12 as a pass is being made across the field 14, the sensor data acquired via the imaging sensor(s) 76 may be geo-located within the field 14. For instance, in various embodiments, the location coordinates derived from the positioning device(s) 74 and the sensor data generated by the imaging sensor(s) 76 may both be time-stamped. In such an embodiment, the time-stamped data may allow the sensor data to be matched or correlated to a corresponding set of location coordinates received or derived from the positioning device(s) 74, thereby allowing a field map to be generated that locates various objects (e.g., targets, weeds, crops, landmarks, etc.) within the field 14 relative to one another.

It should be appreciated that the UAV 12 may also include any other suitable components. For instance, in addition to the imaging sensor(s) 76, the UAV 12 may also include various other sensors 84, such as one or more inertial measurement units for monitoring the orientation of the UAV 12 and/or one or more altitude sensors for monitoring the pose of the UAV 12 relative to the ground. As used herein, “pose” includes the position and orientation of an object, such as the position and orientation of a vehicle, in some reference frame. Moreover, the UAV 12 may include a communications device(s) 78 to allow the UAV computing device 28 to be communicatively coupled to one or more other system components. The communications device 78 may, for example, be configured as a wireless communications device (e.g., an antenna or transceiver) to allow for the transmission of wireless communications between the UAV computing device 28 and one or more other remote system components.

Moreover, as described above with reference to FIG. 1, the system 10 may include or more base stations, such as the base station 32, where each base station 32 may include and/or be configured to support various components, such as one or more computing devices, propulsion systems, UAV refueling-related components, and sensors. For instance, the base station 32 may include the base station computing devices or system(s) 30, the powertrain control system(s) 36, and one or more station positioning device(s) 86. Moreover, the base station 32 may include UAV refueling-related components, such as one or more power-related refueling components (e.g., the powertrain control system(s) 36, the power source station(s) 42, the power transfer assembly (ies) 44, one or more power exchange devices 88, and/or the like), one or more agricultural product-related refueling components (e.g., the refill tanks 40, one or more tank refill device(s) 90, and/or the like), and one or more docking station control components (e.g., one or more retainment devices 92, one or more dock platform actuators 94, one or more dock cover actuators 96, and/or the like). Additionally, while not shown, the base station 32 may include one or more other devices.

Similar to the UAV computing device(s) 28 described above, the base station computing device(s) 30 may correspond to any suitable processor-based device(s), such as a computing device or any combination of computing devices. Thus, in several embodiments, the base station computing device(s) 30 may include one or more processor(s) 80 and associated memory device(s) 82 configured to perform a variety of computer-implemented functions. Additionally, the memory device(s) 82 of the base station 32 may generally be configured to store suitable computer-readable instructions that, when implemented by the processor(s) 80, configure the base station computing device(s) 30 to perform various computer-implemented functions. It should be appreciated that the base station computing device(s) 30 may also include various other suitable components, such as a communications circuit or module, a network interface, one or more input/output channels, a data/control bus, and/or the like.

In several embodiments, the base station computing device(s) 30 may be configured to automatically control the operation of one or more other components of the base station 32. For instance, the base station computing device(s) 30 may be configured to control the powertrain control system 36 of the base station 32. For instance, the base station 32 may be configured to automatically control the powertrain control system 36 in a manner that allows the base station 32 to move. In this regard, the powertrain control system 36 may include any suitable components that allow for the trajectory, speed, and/or the like of the base station 32 to be regulated, such as one or more power sources, one or more drive sources (e.g., one or more motors and/or engines), and/or one or more steering sources. Similarly, as indicated above, the base station computing device(s) 30 may be configured to automatically control the power- related refueling component(s), the agricultural product-related refueling component(s), and/or the docking stations control component(s) in a manner that supports refilling/refueling servicing of the UAVs 12.

In various embodiments, the base station computing device(s) 30 may be configured to monitor the position of the base station 32 to control the propulsion system 16. For instance, the positioning device(s) 86 of the base station 32, similar to the positioning device(s) 74, may be configured to determine the exact location of the base station 32 relative to the field 14 using a satellite navigation position system (e.g. a GPS, a Galileo positioning system, a Global Navigation satellite system (GLONASS), a BeiDou Satellite Navigation and Positioning system, and/or the like), and/or a dead reckoning device. In such embodiments, the location determined by the positioning device(s) 86 may be transmitted to the base station computing device(s) 30 (e.g., in the form of coordinates) and stored within the memory 82 for subsequent processing and/or analysis. In some instances, the location of the base station 32 may be monitored with respect to the location of one or more of the UAVs 12.

It should be appreciated that the base station 32 may also include any other suitable components. For instance, the base station 32 may also include various other sensors, such as one or more inertial measurement units (not shown) for monitoring the orientation of the base station 32. As used herein, “pose” includes the position and orientation of an object, such as the position and orientation of a vehicle, in some reference frame. Moreover, the base station 32 may include a communications device(s) 97 to allow the base station computing device(s) 30 to be communicatively coupled to one or more other system components. The communications device 97 may, for example, be configured as a wireless communications device (e.g., an antenna or transceiver) to allow for the transmission of wireless communications between the base station computing device(s) 30 and one or more other remote system components.

As further shown in FIG. 2, the base station computing device(s) 30 may additionally be configured to be in communication with one or more components of the UAV 12 to allow data to be transferred between the UAV 12 and the base station computing device(s) 30, such as sensor data collected via the positioning device(s) 74, the imaging sensor(s) 76, and/or the like. For instance, as shown in FIG. 2, the base station computing device(s) 30 may also include a communications device(s) 98 to allow for the base station computing device(s) 30 to communicate with the UAV(s) 12. For instance, one or more communicative links or interfaces (e.g., one or more data buses) may be provided between the communications device(s) 98 and the UAV(s) 12.

In various embodiments, the memory device(s) 82 of the base station computing device(s) 30 may include one or more databases for storing information. For instance, as shown in FIG. 2, the memory device(s) 82 may include a field database 100 storing data indicative of field conditions, topology, and/or the like, such as data received from the imaging sensor(s) 76 during a pre-emergence condition (e.g., prior to a seed planting operation in the field 14 or following such operation but prior to the emergence of the plants), during a growing condition (following emergence of plants, prior to harvesting), and/or the like. The image data received may be raw or processed data of one or more portions of the field 14. The field database 100 may also store various forms of data that a related to identified objects within and/or proximate to the field 14. For example, the objects may include targets and/or landmarks that may be used to relocate the targets during a subsequent operation.

In one or more embodiments, the memory device(s) 82 of the base station computing device(s) 30 may include a UAV database 102 for storing data associated with the UAV(s) 12. For instance, the UAV database 102 may include information associated with the configuration of the UAVs 12 (e.g., fill tank capacity, battery requirements, and/or the like), the position data from the positioning device(s) 74 on the UAV(s) 12, data indicative of fill level(s) of the applicator tank(s) 20 on the UAV(s) 12, data indicative of a power level of the power assembly 70 (e.g., estimated remaining battery life of the battery (ies) 18) on the UAV(s) 12, and/or the like.

Similarly, the memory device(s) 82 of the base station computing device(s) 30 may include a base station database 104 for storing data associated with the base station(s) 32. For instance, the base station database 104 may include information with the configuration of the base station 32 (e.g., number of docking stations 38, capacity of the refill tank(s) 40, capacity of the power source station 42, and/or the like), the position data generated by the station positioning device(s) 86 of the base station(s) 32, data indicative of fill level(s) of the refill tank(s) 40 of the base station(s) 32, data indicative of the status of battery (ies) 18 and/or fill level of fuel at the power source station 42, data indicative of the status of the docking station(s) 38, and/or the like.

Referring still to FIG. 2, in several embodiments, the instructions stored within the memory device(s) 82 of the base station computing device(s) 30 may be executed by the processor(s) 80 to implement a field analysis module 106. In general, the field analysis module 106 may be configured to analyze the field data 100 to allow the base station computing device(s) 30 to detect/identify the type of various objects in the field 14. In this regard, the base station computing device(s) 30 may include any suitable image processing algorithms stored within its memory 82 or may otherwise use any suitable image or data processing techniques on the field data 100. For instance, in some embodiments, the base station computing device(s) 30 may be able to distinguish between weeds and emerging/standing crops. Additionally, or alternatively, in some embodiments, the base station computing device(s) 30 may be configured to distinguish between weeds and emerging/standing crops, such as by identifying crop rows of emerging/standing crops and then inferring that plants positioned between adjacent crop rows are weeds.

Moreover, the instructions stored within the memory device(s) 82 of the base station computing device(s) 30 may be executed by the processor(s) 80 to implement a mapping module 108 that is configured to generate one or more maps of the field 14 based on the field data 100. It should be appreciated that, as used herein, a “map” may generally correspond to any suitable dataset that correlates data to various locations within a field 14. Thus, for example, a map may simply correspond to a data table that correlates field data to various locations within the field 14 or may correspond to a more complex data structure, such as a geospatial numerical model that can be used to identify various objects in the field data and determine a position of each object within the field 14, which may, for instance, then be used to generate a graphically displayed map or visual indicator.

Referring still to FIG. 2, in some embodiments, the instructions stored within the memory 82 of the base station computing device(s) 30 may also be executed by the processor(s) 80 to implement a control module 110. In general, the control module 110 may be configured to allow for servicing of the UAVs 12 at the base stations 32. For instance, in general, the operating time for each of the UAVs (e.g., UAVs 12) of a swarm is limited by the capacity of the applicator tanks 20 and/or the capacity of the batteries 18 (or onboard fuel tanks). When an applicator tank 20 is empty or a battery 18 (or onboard fuel tank) is about to run out, the UAV 12 must return to a base station (e.g., base station 32) for a refilling/refueling process. However, the applicator tank(s) 20 of each UAV 12 are typically manually refilled by an operator and/or the battery (ies) 18 of each UAV are manually swapped out (or the fuel tank is manually refilled) by an operator, where such manual servicing processes are time consuming. Moreover, an operator may only effectively service one UAV 12 at a time. As such, the amount of operating time for UAV applicators is severely limited.

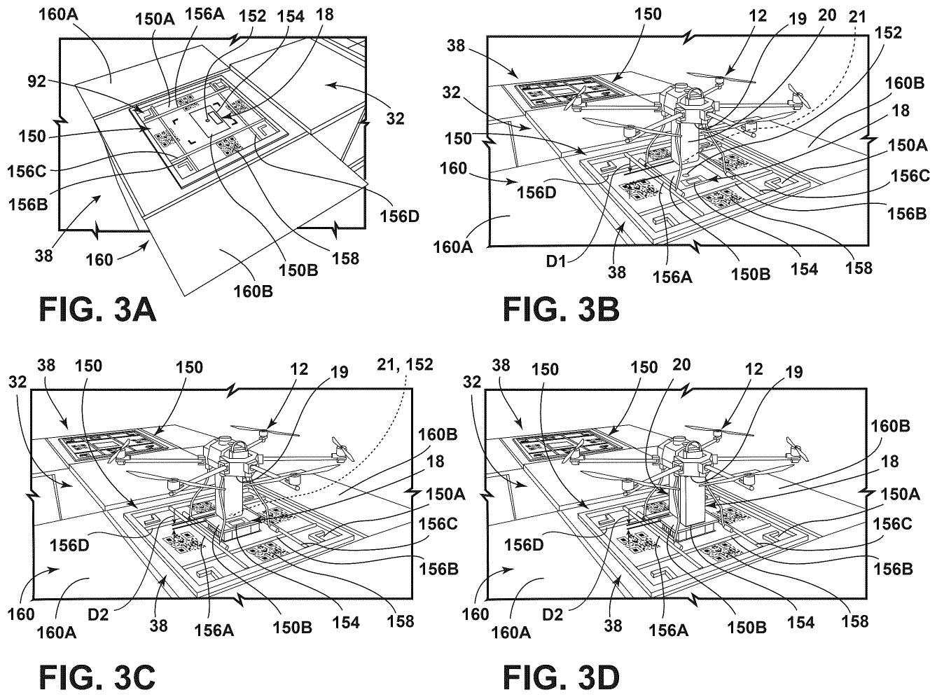

Thus, in accordance with aspects of the present subject matter, the base station 32 is able to help service UAVs 12 in a way that reduces down time for the UAVs and increases productivity of the UAV swarm. For instance, referring now to FIGS. 3A-3D, various views of an example docking station are illustrated in accordance with aspects of the present subject matter. For example, as shown in FIGS. 3A-3D, the base station 32 may include one or more docking stations 38, each of the docking stations 38 having a platform 150 on which a UAV (e.g., the UAV 12) may rest or land, where the docking station(s) 38 may facilitate a refilling or refueling process for the UAV 12 supported thereon. For instance, in the illustrated embodiment shown in FIGS. 3A-3D, the base station 32 includes two docking stations 38, where the docking stations 38 are spaced apart. However, it should be appreciated that the base station 32 may include any other suitable number of docking stations 38, such as only one docking station 38, or three or more docking stations 38. Generally, the more docking stations 38, the higher the potential productivity of a drone swarm.

In some instances, the platform 150 is supported on a roof or other exterior surface of the base station 32 such that the platform 150 may be easily accessible by the UAVs 12 (e.g., for landing). The platform 150 may include at least one opening configured to align with the applicator tank 20 (e.g., a tank port 21 of the applicator tank 20) and the battery 18 (e.g., a battery port 19 for receiving a battery 18) of a UAV 12 supported on the platform 150, where the applicator tank 20 and the battery 18 are configured to be serviced through the at least one opening. For instance, the applicator tank 20 (e.g., the tank port 21 of the applicator tank 20) may be connectable to the refill tank(s) 40 of the base station 32 through the at least one opening. Similarly, the battery port 19 may be configured to receive a battery 18 from the base station 32 through the at least one opening. For instance, in some embodiments, the at least one opening includes a first opening 152 and a second opening 154, where the first opening 152 is configured to align with the applicator tank 20 (e.g., the tank port 21 of the applicator tank 20) of the supported UAV 12, and the second opening 154 is configured to align with the battery 18 (e.g., a battery port 19 for receiving a battery 18) of the supported UAV 12. In some instances, the tank port 21 is located on a lower most surface of the applicator tank 20. Similarly, in some instances, the battery port 19 for receiving a battery (e.g., battery 18) is positioned on a lower surface of the main body of the UAV 12. However, it should be appreciated that any other suitable position of the tank port 21 and/or battery port 19 may instead, or additionally, be used.

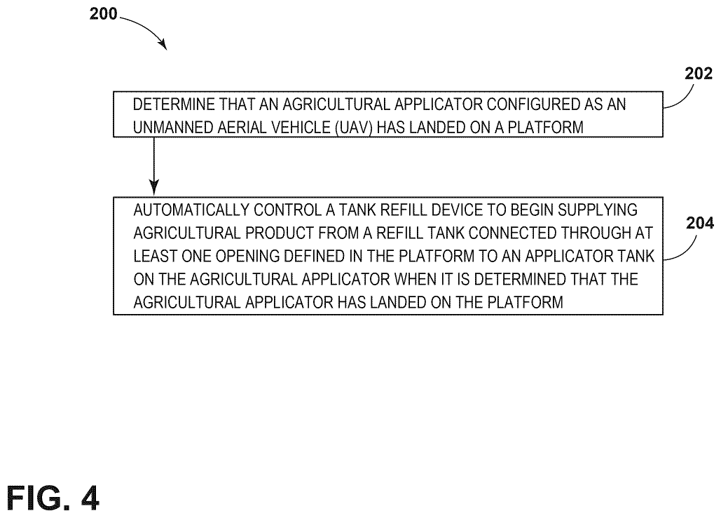

In the illustrated embodiment, the platform 150 includes a first platform portion 150A and a second platform portion 150B, where the second platform portion 150B is movable relative to the first platform portion 150A to facilitate the servicing of the supported UAV 12. For instance, the second platform portion 150B (hereinafter referred to as “the second portion 150B”) may be movable relative to the first platform portion 150A (hereinafter referred to as “the first portion 150A”) between a standby position (FIGS. 3A and 3B) and a servicing position (FIGS. 4A and 4B). In one instance, as shown, the second portion 150B is at least partially surrounded by the first portion 150A, and the second portion 150B defines the at least one opening (e.g., the first and second openings 152, 154). In some embodiments, the second portion 150B is fully encircled by the first portion 150A.

Due to the second portion 150B being movable relative to the first portion 150A, a distance between a supported UAV 12 and the platform 150 is adjustable. For instance, as shown in FIG. 3A, when the platform 150 is waiting for a UAV to land, the second portion 150B is in the standby position, where the second portion 150B is substantially even with (or even below) the first portion 150A. As shown in FIG. 3B, when a UAV (e.g., UAV 12) initially contacts the first portion 150A, the portion of the UAV 12 having the tank port 21 and the battery port 19 extends at least partially over the second portion 150B, and the second portion 150B is spaced apart from the tank port 21 by a first distance D1 (and any battery within the battery port 19). Thereafter, as shown in FIG. 3C, the second portion 150B may then be moved from the standby position into the servicing position, where the tank port 21 is a second distance D2 from the tank port 21 (and any battery within the battery port 19), where the second distance

D2 is smaller than the first distance. For instance, the second distance D2 may be essentially zero, such that the tank port 21 is brought into contact with the second portion 150B and the tank port 21 is connected through the first opening 152 to the refill tank 40 (FIGS. 1 and 2), allowing the applicator tank 20 to be refilled from (or emptied to) the refill tank 40 (e.g., by operating the tank refill device(s) 90 (FIG. 2)). Moreover, in FIG. 3D where the second portion 150B is still in the servicing position, a battery 18 may be moved (e.g., by the power transfer assembly (ies) 44 (FIG. 2)) from the base station 32 (e.g., from the power source station(s) 42 (FIG. 2) through the second opening 154 and into the battery port 19, or vice versa (moved from the battery port 19 through the second opening 154 to the power source station(s) 42 within the base station 32).

It should be appreciated that, by moving the second portion 150B between the standby position and the servicing position, damage to the UAV 12 (e.g., to the applicator tank 20 or attached battery 18) may be avoided when landing on the platform 150. Moreover, the UAV 12 may easily be connected to the refill tank 32 by simply moving the second portion 150B between the standby position and the servicing position. However, it should be appreciated that, in other embodiments, the first portion 150A may instead, or additionally, move relative to the second portion 150B to provide the same benefit(s). Moreover, it should be appreciated that, in some embodiments, part of the second portion 150B defining the first opening 152 may move independently of part of the second portion 150B defining the second opening 154.

Moreover, in one or more embodiments, the platform 150 may include a retainment device (e.g., the retainment device 92) for centering and/or holding the UAV 12 in position during servicing. For instance, the platform 150 includes a plurality of holders 156 (e.g., including a first holder 156A, a second holder 156B, a third holder 156C, and a fourth holder 156D) movable relative to the platform 150. For example, the holders 156 move from a position closer to the outer perimeter of the first portion 150A of the platform 150, as in FIG. 3A, toward the second portion 150B until they at least partially overlap (extend over) the legs (e.g. feet or flanges proximate the lower ends of the legs) of the UAV 12 in a vertical direction, as shown in FIGS. 3B-3D. The movement of the holders 156 may be coordinated such that the legs of the UAV 12 are moved by the holders 156 until the tank port 21 and the battery port 19 align with the first and second openings 152, 154 in the vertical direction. The retainment device(s) 92 may hold the UAV 12 in position such that the UAV 12 (e.g., the tank port 21 and the battery port 19) stays aligned with the at least one opening (e.g., the first and second openings 152, 154) for the servicing operation. Once the servicing operation is finished, the holders 156 may be moved back towards the position shown in FIG. 3A. It should be appreciated that, while the holders 156 are shown as being flat strips, the holders 156 may have any other suitable shape. It should also be appreciated that, in some instances, the UAV 12 may also include one or more features for selectively attaching or holding the UAV 12 the platform 150.

The dock platform actuators 94 (FIG. 2) may be provided for moving the platform portion(s) 150A, 150B and/or the holders 156. The dock platform actuator(s) 94 (FIG. 2) may be configured as any suitable type of actuator, such as a linear actuator (e.g., belt driven, screw driven, and/or the like).

Further, in some embodiments, the platform 150 may further include one or more landing orientation features 158 for orienting the UAV 12 relative to the opening(s) 152, 154. For instance, in some embodiments the UAV 12 may be equipped with one or more sensors (e.g., the imaging sensor(s) 76 from FIG. 2), where the sensor(s) on the UAV 12 may be used to identify the landing orientation feature(s) 158. For example, a field of view of the sensor(s) on the UAV 12 may be configured to align with the landing orientation feature(s) 158 when the applicator tank 20 and/or battery port 19 are aligned with the opening(s) 152, 154. In the illustrated embodiment, the landing orientation feature(s) 158 includes a plurality of QR code(s), where each QR code may have information regarding the orientation of the UAV 12 relative to the desired orientation (e.g., correct orientation, 90 degrees clockwise from correct orientation, 180 degrees from correct orientation, 90 degrees counterclockwise from correct orientation, and/or the like), which may be used to control the UAV 12 into the correct orientation. However, it should be appreciated that the landing orientation feature(s) 158 may include only one QR code or any other suitable identifier(s). For instance, the landing orientation feature(s) 158 may include an arrow(s) or other shape(s), a different colored area(s), and/or the like. Additionally, it should be appreciated that the landing orientation feature(s) 158 on one of the docking station(s) 38 may differ from the landing orientation feature(s) 158 on others of the docking station(s) 38 to help confirm that a UAV 12 is positioned over the desired docking station 38.

As the platforms 150 are positioned on the roof of the base station 32, the platforms 150 may be exposed to the environment, which may cause excess wear on the movable parts (e.g., on the holders 156) and the landing orientation feature(s) 158, or even cause leakage into the interior of the housing of the base station 32 via the opening(s) 152, 154. As such, in one or more instances, each platform 150 may include a movable cover 160 which are movable between a covering position (not shown), where the platform 150 (e.g., the opening(s) 152, 154 of the platform 150) is at least partially covered by the cover 160, and an opened position, where the platform 150 (e.g., the opening(s) 152, 154 of the platform 150) is at least partially uncovered and accessible for performing the servicing operation. In some embodiments, the cover 160 has one or more cover portions which may be movable relative to the platform 150 to cover or uncover the platform 150. For instance, in the illustrated embodiment, the cover 160 includes a first cover portion 160A and a second cover portion 160B, where the first and second cover portions 160A, 160B extend from opposite sides of a platform 150 when in the opened position. The cover 160 (e.g., the cover portions 160A, 160B) may be movable in any suitable manner relative to the platform 150 between the covering and opened positions. For instance, the cover 160 may be slidable, pivotable, or a combination thereof relative to the platform 150. The dock cover actuator(s) 96 (FIG. 2) may be controllable to move the cover 160 (e.g., the cover portions 160A, 160B) between the uncovered and opened positions. It should be appreciated that the dock cover actuator(s) 96 (FIG. 2) may be any suitable type of actuator that allow for the movement between the uncovered and opened positions. Moreover, it should be appreciated that, while the cover 160 has been shown as having the two portions 160A, 160B, the cover 160 may have any other suitable number of portions, such as only one portion, or three or more portions.

Referring back to FIG. 2, in some instances, the control module 110 may be configured to make the docking station(s) 38 ready for servicing the UAVs 12. For instance, the control module 110 may determine that a spraying operation is about to begin or has already begun, and/or that a UAV 12 is going to need servicing (e.g., based on the UAV data 102) and/or based on an operator input indicative of a request to prepare for a servicing operation. In response to such determination(s), the control module 110 may be configured to control the operation of the dock cover actuator(s) 96 to move the cover(s) 160 to the opened position (FIGS. 3A-3D).

The control module 110 may, in some instances, determine when a UAV (e.g., one of the UAVs 12) is present at one of the docking stations 38. For instance, in some embodiments, the control module 110 may compare the position of the UAV(s) 12 to the position of the docking station(s) 38 (e.g., based at least in part on the position of the base station 32 determined from the station positioning device(s) 86 and a known distance(s) of the docking station(s) 38 from the positioning device(s) 86). If the position of one of the UAV(s) 12 matches with the position of one of the docking station(s) 38, the control module 110 may determine that the UAV is on the docking station(s) 38. In some instances, the image sensor(s) 76 on the UAV(s) 12 may be used to detect the landing orientation feature(s) 158 on the platform(s) 150 and properly orient the UAV(s) relative to the opening(s) 152, 154, as described above, and may additionally, or alternatively, be used by the control module 110 to determine when the UAV(s) 12 has landed on the docking station(s) 38. Alternatively, or additionally, in some embodiments, the UAV(s) 12 and/or the platform(s) 150 may include a proximity sensor (e.g., distance sensor, Hall-effect sensor, and/or the like) which may be used by the control module 110 to determine when the UAV(s) 12 has landed on the docking station(s) 38.

When it is determined that the UAV(s) 12 has landed on the docking station(s) 38, in some instances, the control module 110 may control the operation of one or more components of the base station 32 to fix or couple the UAV(s) 12 in position on the docking station(s) 38. For instance, the control module 110 may control an operation of the retainment device(s) 92, as described above with reference to FIGS. 3A-3D, to fix or couple the UAV(s) 12 in position on the docking station(s) 38 such that the UAV(s) 12 cannot move relative to the docking station(s) 38 until the retainment device(s) 92 have been operated to uncouple the UAV(s) 12 from the docking station(s) 38.

Thereafter, in some instances, the control module 110 may be configured to control the operation of one or more components of the base station 32 to couple the applicator tank(s) 20 to the refill tank(s) 40. For instance, the control module 110 may be configured to control the operation of the dock platform actuator(s) 94, as described above with reference to FIGS. 3B-3D, to move the first portion 150A of the platform 150 relative to the second portion 150B of the platform 150, and/or vice versa, such that the distance between the tank port 21 and the first opening 152 is reduced and such that the tank port 21 is connected to the refill tank(s) 40 through the at least one opening in the platform 150 (e.g., the first opening 152). When the tank port 21 is connected to the refill tank(s) 40, the control module 110 may control the operation of the tank refill device(s) 90 to cause the agricultural product in the refill tank(s) 40 to be supplied to the applicator tank 20 and/or to drain agricultural product from the applicator tank 20 into the refill tank(s) 40. It should be appreciated that the tank refill device(s) 90 may include any suitable devices or combinations of devices, such as a pump, a compressor, and/or the like.

It should be appreciated that the UAV 12, the tank refill device(s) 90, the refill tank(s) 40, and/or the platform 150 may have any suitable sensors for detecting the fill level of the applicator tank(s) 20 and/or the refill tank(s) 40 and/or device(s) for automatically stopping the filling/draining of the applicator tank(s) 20. For instance, the applicator tank(s) 20 and/or the refill tank(s) 40 may have sensors therein (e.g., float-based sensors, pressure sensor(s), and/or the like) for generating data indicative of the fill level in the tank(s) 20, 40, where the control module 110 may determine the fill level in the tank(s) 20, 40 and control the operation of the tank refill device(s) 90 to begin and/or stop flow between the tanks 20, 40 based at least in part on the fill level in the tank(s) 20, 40. For example, if the applicator tank(s) 20 is full, the control module 110 may control the operation of the tank refill device(s) 90 to stop flow from the refill tank(s) 40 to the applicator tank(s) 20. In some instances, a pilot valve(s) may be provided between the applicator tank(s) 20 and the refill tank(s) 40 that closes when the applicator tank(s) 20 is full when filling the applicator tank(s) 20 and/or that closes when the refill tank(s) 40 is full when draining the applicator tank(s) 20.

In some instances, the control module 110 may be configured to control the operation of one or more components of the base station 32 to remove a power source from or supply a power source to the UAV 12. For instance, the control module 110 may control the operation of the power transfer assembly (ies) 44 to move a battery 18 (e.g., from the power source station(s) 42) through the at least one opening in the platform (e.g., the second opening 154) and into the battery port 19, as described above with reference to FIGS. 3C-3D. In such instances, the power transfer assembly (ies) 44 may include any suitable transfer device or combination of device(s), such as a linear actuator. While not described in greater detail, the power source station(s) 42 may be configured to hold and/or recharge batteries 18, where in some instances, the powertrain control system 36 may be controllable by the control module 110 to recharge the battery (ies) 18. In some embodiments, the UAV 12 may additionally, or alternatively, be powered by a liquid fuel, where in which case, the power transfer assembly (ies) 44 may, similar to the tank refill device(s) 90, include a pump, a compressor, and/or the like controllable by the control module 110 to cause the liquid fuel to be supplied from a refueling tank(s) of the power source station(s) 42 to a fuel tank port(s) for a fuel tank(s) on the UAV 12. In such instances, the fuel tank port may be on a lower surface of the fuel tank similar to the applicator tank port 21, and connectable to the refueling tank by moving the first portion 150A of the platform 150 relative to the second portion 150B of the platform 150, and/or vice versa. In such instances, the fuel tank(s) on the UAV(s) 12, the refueling tank(s) on the base station 32, and/or the power transfer assembly (ies) 44 may have any suitable sensors and/or valves that may be used to determine the fill level of the fuel tank(s) and/or the refueling tank(s) to control the operation of the power transfer assembly (ies) 44, similar to as described above with reference to the applicator tank(s) 20 and the refill tank(s) 40.

Once it is determined that the UAV(s) 12 have sufficient agricultural product and power supply, the control module 110 may end the servicing operation. For instance, the control module 110 may control the operation of the retainment device(s) 92 to uncouple the UAV(s) 12 from the docking station(s) 38. In some instances, the control module 110 may control the operation of the dock platform actuator(s) 94 to move the portion(s) 160A, 160B back into the standby position. Moreover, in some instances, the control module 110 may control the operation of the dock cover actuator(s) 96 to move the dock cover 160 back into the covering position when the UAV(s) 12 are no longer detected at the docking station(s) 38 and/or when the spraying operation is complete.

As such, the disclosed system 10 may allow for servicing of agricultural applicator(s) configured as UAVs that significantly reduces downtime for UAV applicators and thus, increases productivity of UAV applicators for performing agricultural operations.

It should be appreciated that, while the field analysis module 106, the mapping module 108, and control module 110 are discussed as being performed by the base station computing device(s) 30 as part of the base station 32, such modules may instead, or additionally, be performed by computing device(s) corresponding to a stand-alone component or may be incorporated into or form part of a separate component or assembly of components. For example, the computing system(s) 30 performing such modules may be incorporated into or form part of the UAV(s) 12 and/or the cloud computing system 46.

Referring now to FIG. 4, a flow diagram of some embodiments of a method 200 for servicing an agricultural applicator is illustrated in accordance with aspects of the present subject matter. In general, the method 200 will be described herein with reference to the one or more UAVs, and the system 10 described above with reference to FIGS. 1-3D. However, it will be appreciated by those of ordinary skill in the art that the disclosed method 200 may generally be utilized with any suitable agricultural vehicles and/or may be utilized in connection with a system having any other suitable system configuration. In addition, although FIG. 4 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 4, at (202), the method 200 can include determining that an agricultural applicator configured as an unmanned aerial vehicle (UAV) has landed on a platform. For instance, as described above, the control module 110 may determine when the UAV 12 has landed on the platform 150 of a docking station 38 on the base station 32. For example, the control module 110 may monitor the UAV data 102, the base station data 104, and/or the like to determine when the UAV 12 has landed on the platform 150.

Additionally, at (204), the method 200 may include automatically controlling a tank refill device to begin supplying agricultural product from a refill tank connected through at least one opening defined in the platform to an applicator tank on the agricultural applicator when it is determined that the agricultural applicator has landed on the platform. For instance, as discussed above, when the control module 110 determines that the UAV 12 has landed on the platform 150, the control module 110 may control the tank refill device(s) 90 to begin supplying agricultural product from the refill tank(s) 40 on the base station 32 connected through the at least one opening (e.g., the first opening(s) 152) defined in the platform 150 to the applicator tank(s) 20 on the UAV 12.

In various examples, the method 200 may implement machine learning methods and algorithms that utilize one or several machine learning techniques including, for example, decision tree learning, including, for example, random forest or conditional inference trees methods, neural networks, support vector machines, clustering, and Bayesian networks. These algorithms can include computer-executable code that can be retrieved by the computing system and/or through a network/cloud and may be used to evaluate and update models used for controlling servicing of the applicators. In some instances, the machine learning engine may allow for changes to the models used for controlling servicing of the applicators to be performed without human intervention.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the computing device, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for servicing an agricultural applicator, the system comprising:
an agricultural applicator configured as an unmanned aerial vehicle (UAV) configured to fly over a field, the agricultural applicator comprising:
an applicator tank for holding agricultural product configured to be dispensed by the agricultural applicator during an application operation; and
a power source port configured to receive a power source for powering the agricultural applicator;
a platform on which the agricultural applicator is configured to rest during a servicing operation, the platform defining at least one opening;
a refill tank configured to hold the agricultural product, the refill tank being connectable during the servicing operation to the applicator tank through the at least one opening for supplying the agricultural product from the refill tank to the applicator tank; and
a power source station, the power source station supplying the power source to the power source port through the at least one opening during the servicing operation.

2. The system of claim 1, wherein the at least one opening includes a first opening configured to align with the applicator tank and a second opening configured to align with the power source port when the agricultural applicator rests on the platform.

3. The system of claim 2, further comprising a holder controllable to selectively fix the agricultural applicator to the platform such that the at least one opening stays aligned with the applicator tank and the power source port during the servicing operation.

4. The system of claim 2, wherein a tank port of the applicator tank is configured to align with the first opening when the agricultural applicator rests on the platform.

5. The system of claim 4, wherein the tank port is defined in a lower surface of the applicator tank.

6. The system of claim 1, wherein the platform includes a first portion and a second portion, the agricultural applicator being configured to rest on the first portion, the second portion being at least partially surrounded by the first portion, the at least one opening being defined in the second portion, one or both of the first portion or the second portion being movable such that a distance between a tank port of the applicator tank and the second portion is adjustable.

7. The system of claim 1, wherein the power source is a battery, the system further comprising a power transfer assembly, the battery being selectively movable by the power transfer assembly from the power source station through the at least one opening and at least one of into or out of the power source port.

8. The system of claim 1, wherein the power source is fuel, the power source station being a refueling tank configured to hold the fuel, the power source port being a fuel tank port of a fuel tank on the agricultural applicator, the refueling tank being connectable to the fuel tank port through the at least one opening.

9. The system of claim 1, further comprising a cover movable relative to the platform between a covering position and an opened position, the cover in the covering position being configured to at least partially cover the at least one opening, the at least one opening configured to be uncovered when the cover is in the opened position.

10. The system of claim 9, further comprising a cover actuator selectively controllable to move the cover between the covering position and the opened position.

11. The system of claim 1, wherein the platform is defined on a roof of a storage housing, the at least one opening extending through the roof to an interior volume defined by the storage housing, the refill tank and the power source station being at least partially received within the interior volume.

12. The system of claim 11, wherein the storage housing is supported on one or more wheels.

13. A base station for servicing agricultural applicators configured as unmanned aerial vehicles (UAVs), the base station comprising:
a frame;
a storage housing supported on the frame and defining an interior volume;
a platform defined on a roof of the storage housing, at least one opening being defined through the platform and the roof of the storage housing to the interior volume of the storage housing; and
a refill tank within the storage housing, the refill tank configured to hold agricultural product, the refill tank being connectable to a tank on an agricultural applicator through the at least one opening during a servicing operation.

14. The base station of claim 13, wherein the platform includes a first portion and a second portion at least partially surrounded by the first portion, the at least one opening being defined in the second portion, one or both of the first portion being movable relative to the second portion or the second portion being movable relative to the first portion.

15. The base station of claim 13, further comprising a power source station within the storage housing, the power source station configured to provide a power source to a power source port of an agricultural applicator through the at least one opening during the servicing operation.

16. A method for servicing an agricultural applicator, the method comprising:
determining, with a computing system, that an agricultural applicator configured as an unmanned aerial vehicle (UAV) has landed on a platform; and
automatically controlling, with the computing system, a tank refill device to begin supplying agricultural product from a refill tank connected through at least one opening defined in the platform to an applicator tank on the agricultural applicator when it is determined that the agricultural applicator has landed on the platform, the agricultural product being dispensable from the agricultural applicator during an application operation.

17. The method of claim 16, wherein determining that the agricultural applicator has landed on the platform comprises receiving data indicative of a landing orientation feature on the platform being within a field of view of a sensor on the agricultural applicator, the landing orientation feature being within the field of view of the sensor when the applicator tank is aligned with the at least one opening.

18. The method of claim 16, further comprising controlling, with the computing system, a holder to fix the agricultural applicator to the platform when it is determined that the agricultural applicator has landed on the platform such that the at least one opening is aligned with the applicator tank during a servicing operation.

19. The method of claim 16, wherein the platform comprises a first portion and a second portion, the agricultural applicator being configured to rest on the first portion, the second portion being at least partially surrounded by the first portion, the at least one opening being defined in the second portion,
the method further comprising controlling, with the computing system, a platform actuator to move at least one of the first portion or the second portion of the platform when it is determined that the agricultural applicator has landed on the platform to connect the refill tank through the at least one opening to the applicator tank.

20. The method of claim 16, further comprising controlling, with the computing system, a power transfer assembly to move a battery through the at least one opening defined in the platform and at least one of into or out of a battery port of the agricultural applicator when it is determined that the agricultural applicator has landed on the platform, the battery being usable to power the agricultural applicator.
